(19) United States
(12) Patent Application Publication
(10) Pub. No.: US 2003/0040217 A1
(43) Pub. Date: Feb. 27, 2003

(54) Device mounting system

(75) Inventors: Scott W. Renne, Bellingham, WA (US); Kevin L. Lacy, Bellingham, WA (US); Donald P. Aupperle, Seattle, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Blue Sea Systems

(21) Appl. No.: 10/226,468

(22) Filed: Aug. 23, 2002

Related U.S. Application Data
(60) Provisional application No. 60/314,832, filed on Aug. 24, 2001.

(51) Int. Cl. H01R 13/60

(52) U.S. Cl. 439/543

(57) ABSTRACT

A housing to secure a device to a panel. The housing has a case, a locking ring and a nut. The locking ring has locking protrusions that help to prevent the housing from coming loose from the panel. The case may also have a keyway and the locking ring a corresponding key. The nut may also have detents to engage the locking protrusions on one side of the locking ring.

### BACKGROUND OF THE INVENTION

Meters, switches, and other devices must frequently be secured to panels in environments that are subject to substantial vibrations and severe weather conditions. For example, instrument panels in boats are frequently subject to vibration and exposure to water. Therefore, it can be appreciated that there is a need for a housing to secure devices to a panel such that the housing is resistant to coming loose when exposed to vibration. Further, it can be appreciated that it is desirable for such a housing to provide some protection for the device from exposure to the elements.

1. Field of the Invention

This invention relates to a housing for a device, and in particular, to a housing for securing a device to a panel.

### BRIEF SUMMARY OF THE INVENTION

In one aspect, disclosed is a housing to secure a device to a panel. The housing has a case to hold the device, a nut, and a locking ring. The case has a head, or bezel, and a threaded portion matching the threads in the nut. The locking ring contains protrusions that, as the nut is tightened on the threaded portion of the case, create a force tending to hold the housing in place and to prevent the nut from coming loose when the housing is subjected to vibration. The threaded portion of the housing may also have a slot through the threads and the locking ring may contain a corresponding protrusion to position the locking ring with respect to the threaded portion of the housing. The case may also have a mechanism for holding the case in place on the panel, such as a seal, a sticky surface, or the like.

Other features and advantages will become apparent from the following detailed description, taken in conjunction with the accompanying drawings.

### BRIEF DESCRIPTION OF THE SEVERAL VIEWS OF THE DRAWINGS

FIG. 1 is an exploded front, left, top isometric view of a device housing.

FIG. 2 is an exploded rear, left, top isometric view of a device housing.

FIG. 3 is a top plan view of a device housing.

FIG. 4 is a front, right, top isometric view of a device housing.

FIG. 5 is a rear, left, top isometric view of a device housing.

FIG. 6 is a front elevational view of a device housing.

FIG. 7 is a right side elevational view of a device housing.

FIG. 8 is a rear elevational view of a device housing.

### DETAILED DESCRIPTION OF THE INVENTION

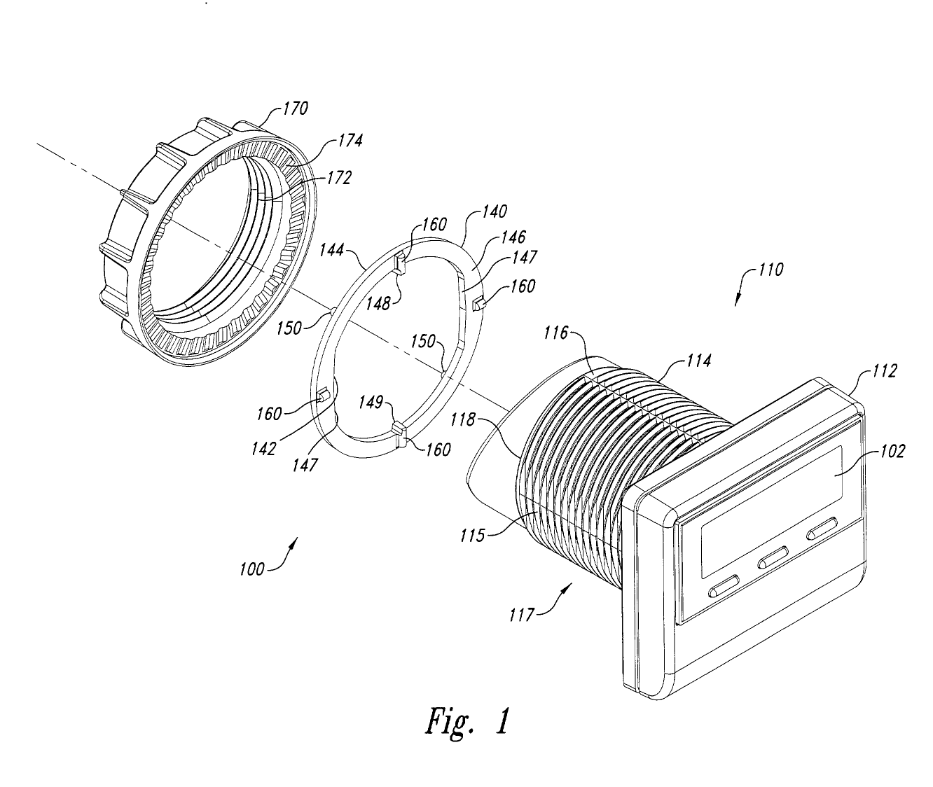

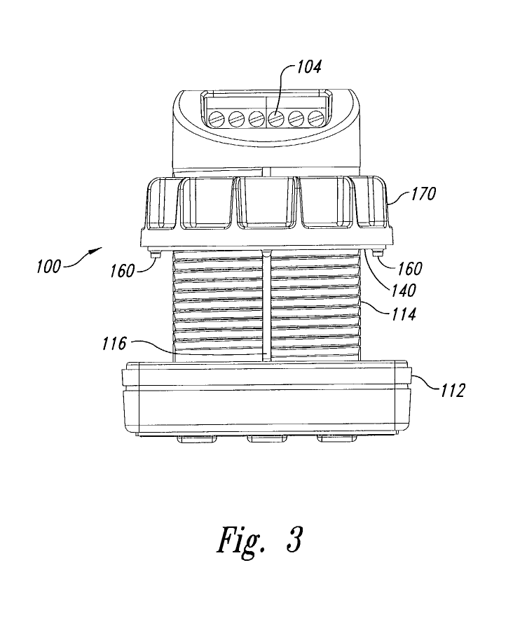

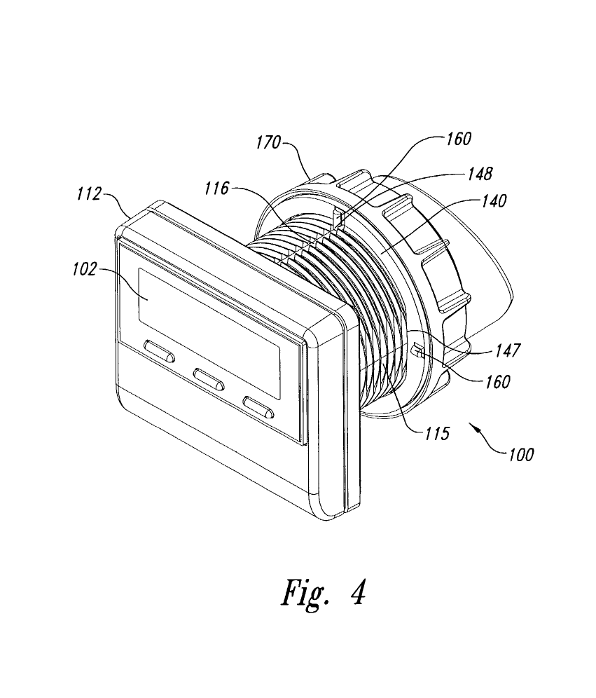

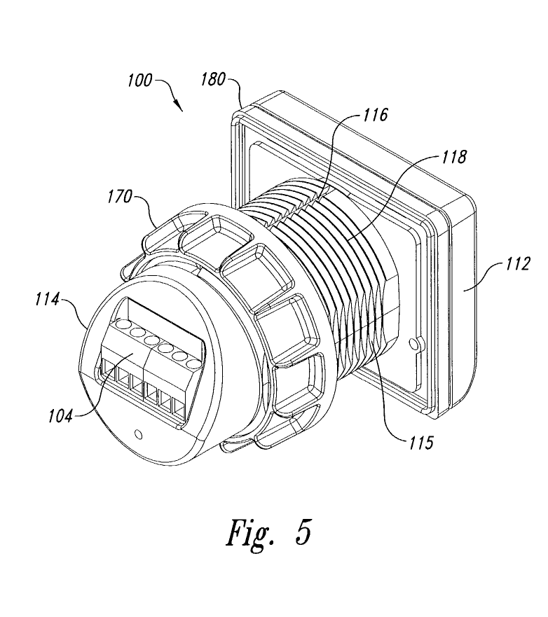

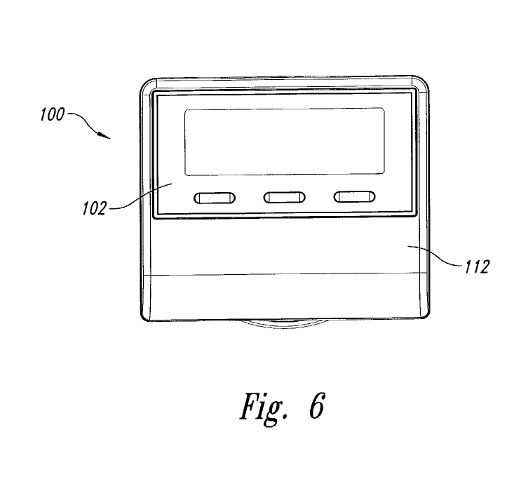

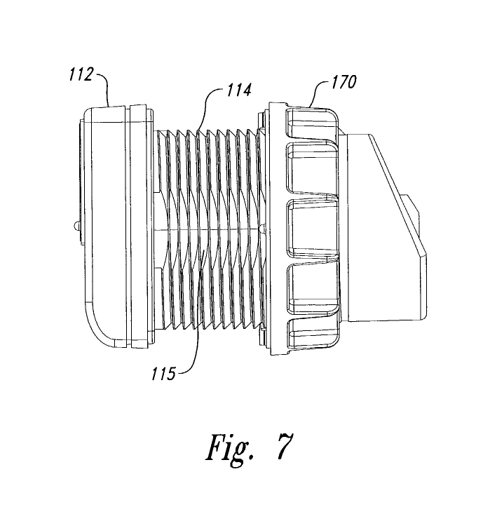

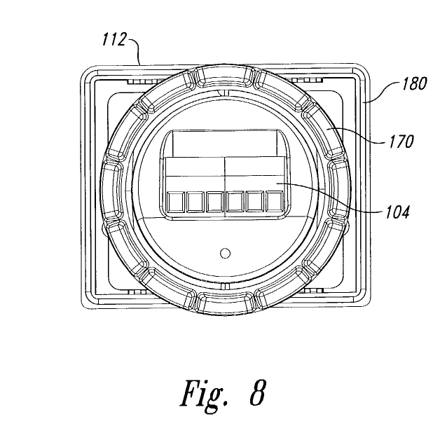

FIGS. 1-8 show a housing 100 having a case 110 to house a device, such as device 102, to secure the device to a panel. The case 110 has a head 112 and a stem or threaded portion 114. The threaded portion 114 has keyways or positioning slots 116, 117 formed in the threads 118 of the threaded portion 114.

The housing 100 also has a washer or locking ring 140, having an annular inner surface 142 and two faces or sides 144, 146. The locking ring 140 has keys or positioning protrusions 148, 149 on the inner surface 142 oriented, sized and dimensioned to be received by the keyways or positioning slots 116, 117 in the threads 118 of the threaded portion 114 of the case 110.

One of skill in the art will recognize that the positioning protrusions 148, 149 may be of various shapes. For example, they may have a rectangular or a curved cross section, or some combination thereof. One of skill in the art will recognize that the thickness of a positioning protrusion 148 need not correspond to the thickness of the locking ring 140.

In other embodiments, the threaded portion 114 of the case 110 may have a single positioning slot 116 and the locking ring 140 may have a corresponding positioning protrusion 148, or an alternative positioning mechanism may be employed, one example of which is discussed in more detail below or in a further alternative no positioning mechanism may be employed. A positioning mechanism holds the locking ring in place, facilitating warping of the locking ring, discussed in more detail below, and helps to prevents spinning of the locking ring against the panel. Adding a positioning mechanism, however, also complicates the design and assembly of the housing.

The locking ring 140 has a plurality of locking protrusions 150, 160 on corresponding sides 144, 146. The locking protrusions 150 on one side 144 are angularly displaced with respect to the locking protrusions 160 on the other side 146. In other words, the locking protrusions 150 on one side 144 are offset from the locking protrusions 160 on the other side 146. One of skill in the art will also recognize that the locking protrusions 150,160 may be of various shapes and need not correspond to the thickness of the locking ring 140.

The housing 100 also has a nut 170 with internal threads 172 sized and dimensioned to threadedly engage the threads 118 of the threaded portion 114 of the case 110. As the nut 170 is tightened on the case 110, the positioning protrusions 148, 149, resist rotation but allow translation of the locking ring 140 with respect to the case 110. The locking protrusions 150, 160 will thus cause the locking ring 140 to warp. The warping of the locking ring 140 creates a force to prevent the nut 170 from loosening even when the housing 100 is subjected to vibrations. One of skill in the art will also recognize that a positioning protrusion 148 may be aligned with one of the plurality of locking protrusions 160 on one side 146 of the locking ring 140. The various parts of the housing 100 may be made of plastic, rubber, metal, or other suitable materials, and various combinations thereof.

As best illustrated in FIG. 1, the nut 170 has detents 174 to engage the locking protrusions 150 on one side 144 of the locking ring 140. The threaded portion 114 of the case 110 also has flat portions 115 and the locking ring 140 has complementary flat portions 147. The flat portions 115 of the threaded portion 114 of the case 110 and the complimentary flat portions 147 of the locking ring 140 serve as an additional positioning mechanism.

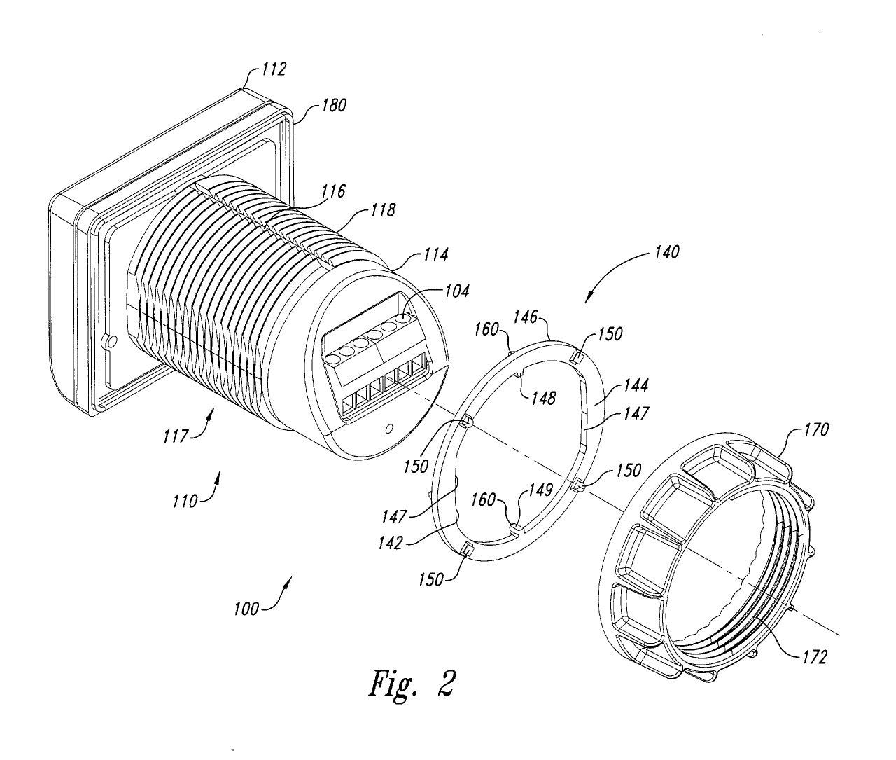

As best illustrated in FIG. 2, the housing 100 also incorporates a mechanism for sealing the case to the panel, such as a gasket 180. One of skill in the art will recognize that another conventional seal or a gummy surface or the like may be used. The mechanism may also seal the housing 100 to the panel (not shown) when the housing 100 is assembled, and thus provide some protection against water entering the panel (not shown) through the hole in the panel through which the housing 100 is mounted.

The threaded portion 114 of the case 110 is hollow and contains electrical connections 104 for the device (see FIG. 1). Thus, use of a hollow threaded portion 114 allows room for the device or for electrical 104 or mechanical (not shown) connections to the device.

All of the above U.S. patents, U.S. patent application publications, U.S. patent applications, foreign patents, foreign patent applications and non-patent publications referred to in this specification and/or listed in the Application Data Sheet, including but not limited to Provisional U.S. Patent Application No. 60/314,832, filed Aug. 24, 2001, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and equivalents thereto.

We claim:

1. A housing to secure a device to a panel, comprising:
a case to house the device, the case having a head and a threaded portion with at least one positioning slot formed in the threads of the threaded portion;
a locking ring having an annular inner surface and two opposed faces, at least one positioning protrusion on the inner surface, the positioning protrusion sized, dimensioned and orientable to be received by the positioning slot in the threads of the threaded portion of the case, and a plurality of locking protrusions on each face; and
a nut having threads sized and dimensioned to be threadedly received by the threads of the threaded portion of the case.

2. The housing of claim 1 wherein the nut has detents to engage the plurality of locking protrusions on one face of the locking ring.

3. The housing of claim 1 wherein the case has a plurality of positioning slots in the threads of the threaded portion of the case, and the locking ring has a complementary plurality of positioning protrusions.

4. The housing of claim 1, further comprising a seal to seal the case to the panel.

5. The housing of claim 1 wherein the positioning protrusion has a rectangular cross-section.

6. The housing of claim 1 wherein the case, the locking ring, and the threaded nut are plastic.

7. The housing of claim 1 wherein the threaded portion of the case has a flat portion and the annular inner surface of the locking ring has a complementary flat portion.

8. The housing of claim 1, wherein the threaded portion of the case is hollow.

9. A housing to secure a device in a panel comprising:
a mount to house the device, the mount having a head and a stem, the stem having threads and a positioning slot through the threads;
a locking ring having sides and an inner portion, wherein the sides of the locking ring have offset protrusions perpendicular to the sides and the inner portion has a positioning protrusion complementary to the positioning slot of the stem; and
a nut having threads sized and dimensioned to be threadedly received by the threads of the stem of the mount.

10. A housing to secure a device to a panel, comprising:
a case to house the device, the case having a head and a threaded portion with a flat portion in the threads of the threaded portion;
a locking ring having an inner surface and two faces, a flat portion on the inner surface corresponding to the flat portion in the threads of the threaded portion of the case, and a plurality of locking protrusions on each face; and
a nut having a threaded passage for threadedly receiving the threads of the threaded portion of the case.

11. The housing of claim 10 wherein the nut has detents to engage the plurality of protrusions on one face of the locking ring.

12. The housing of claim 10 wherein the case has a keyway in the threads of the threaded portion of the case, and the locking ring has a complementary key.

13. A housing to secure a device to a panel, comprising:
a case to house the device, the case having a head and a threaded male portion;
a ring having a locking member;
means for positioning the ring on the threaded portion of the case; and
a nut having a threaded female portion for threadedly receiving the threaded male portion of the case.

14. A housing to secure a device to a panel comprising:
a case to house the device, the case having a head and a threaded portion;
a nut having threads complementary to the threaded portion of the case; and
a locking ring having two faces and a plurality of locking protrusions on each face for engaging the panel and the nut, respectively, and causing the locking ring to warp and prevent rotation of the housing with respect to the panel.

15. The housing of claim 14, wherein the nut has detents to engage the plurality of protrusions on one face of the locking ring.
